(19) United States
(12) Patent Application Publication
(10) Pub. No.: US 2017/0213308 A1
(43) Pub. Date: Jul. 27, 2017

(54) ARBITRATION OF PASSENGER PICKUP AND DROP-OFF AND VEHICLE ROUTING IN AN AUTONOMOUS VEHICLE BASED TRANSPORTATION SYSTEM

(71) Applicant: GM GLOBAL TECHNOLOGY OPERATIONS LLC, Detroit, MI (US)

(72) Inventors: CARL W. WELLBORN, DETROIT, MI (US); JASON E. DIEHL, WASHINGTON TOWNSHIP, MI (US); MARY E. DECALUWE, OXFORD, MI (US); THOMAS A. BARTH, MACOMB TOWNSHIP, MI (US)

(73) Assignee: GM GLOBAL TECHNOLOGY OPERATIONS LLC, Detroit, MI (US)

(21) Appl. No.: 15/405,099

(22) Filed: Jan. 12, 2017

Related U.S. Application Data
(60) Provisional application No. 62/287,425, filed on Jan. 26, 2016.

(51) Int. Cl. G06Q 50/30; G01C 21/34; B60R 25/24; G08G 1/00

(52) U.S. Cl. CPC G06Q 50/30; G08G 1/202; G01C 21/3453; B60R 25/24

(57) ABSTRACT

Enhanced features of a vehicle based transportation system are presented here. In accordance with one methodology, the transportation system processes ride requests for multiple passengers of an autonomous vehicle based transportation system. Each ride request is associated with a respective pickup location and a respective destination location. The system calculates a respective passenger transportation route for each actively operating autonomous vehicle, wherein each passenger transportation route is based at least in part on the pickup locations and destination locations associated with the ride requests, and wherein each passenger transportation route is calculated in accordance with predetermined prioritization criteria. The actively operating autonomous vehicles are controlled in a desired manner to satisfy at least some of the ride requests.

### CROSS-REFERENCE TO RELATED APPLICATION

This application claims the benefit of U.S. provisional patent application No. 62/287,425, filed Jan. 26, 2016.

### TECHNICAL FIELD

Embodiments of the subject matter described herein relate generally to transportation systems. More particularly, embodiments of the subject matter relate to enhanced features suitable for use in an autonomous vehicle based transportation system.

### BACKGROUND

Driverless vehicles have been under development for several years. An autonomous vehicle uses onboard sensor systems, global positioning system (GPS) technology, navigation systems, and drive-by-wire systems to transport passengers on roads that may be occupied by traditional vehicles and/or other autonomous vehicles.

It is desirable to have enhanced features, operating methods, and functions in an autonomous vehicle transportation system. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram that illustrates an autonomous vehicle based transportation system and related systems and subsystems;

FIG. 2 is a block diagram of an exemplary embodiment of a processor-based hardware platform suitable for use in various system components described herein;

FIG. 3 is a flow chart that illustrates an exemplary embodiment of a passenger pickup and drop-off arbitration process; and

FIG. 4 is a flow chart that illustrates an exemplary embodiment of a rendezvous anywhere process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

For the sake of brevity, conventional techniques related to the control and operation of autonomous (i.e., driverless or self-driving) vehicles, mobile client devices, navigation and mapping systems, the global positioning system (GPS), security and access control systems, shipping and delivery systems, signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter described herein relates to a vehicle based transportation system. In certain implementations, the vehicle based transportation system includes at least one driverless vehicle that is automatically controlled to carry passengers from one location to another. In practice, however, the concepts presented herein can also be utilized with a transportation that includes traditional (non-autonomous) vehicles. Although the exemplary embodiments are particularly suitable for use in the context of a taxi or shuttle system in a relatively small geographical area (such as a school or business campus, a shopping center, an amusement park, an event center, or the like), the techniques and technologies presented herein are not limited to such an application. For example, autonomous and/or remotely controlled drone vehicles, which may be ground-based or air-based, can be managed and controlled in accordance with the methodologies described herein. The disclosed subject matter provides certain enhanced features and functionality to what may be considered as a standard or baseline autonomous vehicle system. To this end, an autonomous vehicle based transportation system can be modified, enhanced, or otherwise supplemented to provide the additional features mentioned in more detail below.

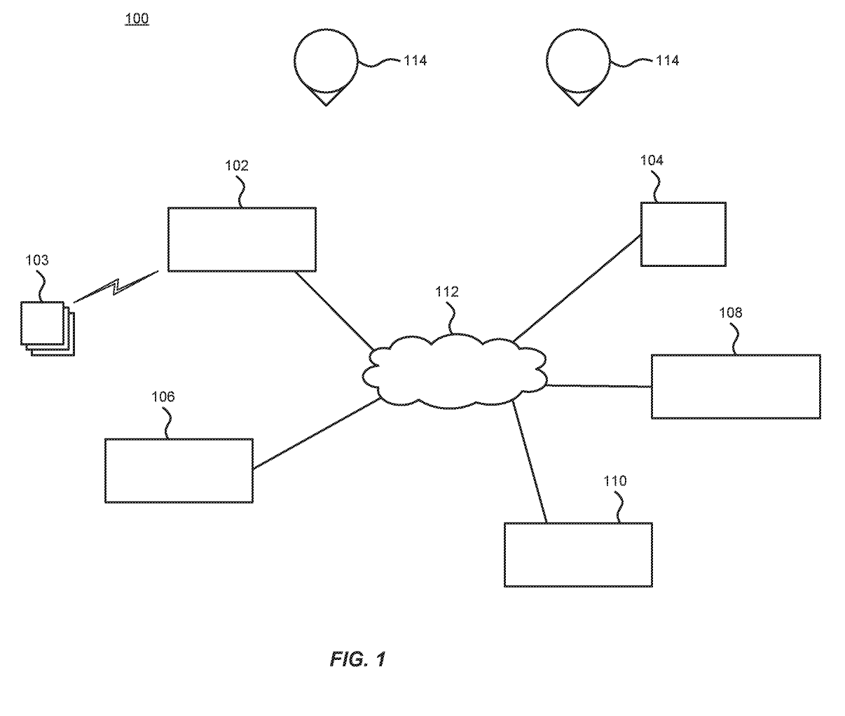

FIG. 1 is a simplified block diagram of an exemplary embodiment of an operating environment 100 that includes an autonomous vehicle based transportation system 102 and related systems and subsystems. The techniques and methodologies described with reference to the operating environment 100 can also be implemented in the context of other system architectures and environments. The operating environment 100 described here represents one practical scenario that can benefit from certain enhanced features. The illustrated embodiment of the operating environment 100 includes, without limitation: the transportation system 102; at least one user device 104; a security and access system 106; a shipping/delivery system 108; a navigation and map system 110; and a communication network 112. Certain devices or systems in the operating environment can communicate with global positioning system (GPS) satellites 114, only two of which are depicted in FIG. 1. The devices, systems, and components supported by the operating environment 100 can communicate with one another (via tangible communication links and/or wireless communication links) as needed via the communication network 112.

Although only one user device 104 is shown in FIG. 1, an embodiment of the operating environment 100 can support any number of user devices 104, including multiple user devices 104 owned, operated, or otherwise used by one person. Each user device 104 supported by the operating environment 100 may be implemented using any suitable hardware platform. In this regard, a user device 104 can be realized in any common form factor including, without limitation: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 104 supported by the operating environment 100 is realized as a computer-implemented or computer-based device having the hardware, software, firmware, and/or processing logic needed to carry out the various techniques and methodologies described in more detail herein.

The autonomous vehicle based transportation system 102 includes one or more driverless (autonomous) vehicles, which are identified in FIG. 1 as AVs 103, along with the corresponding onboard native processing, control, and computing intelligence and logic. An AV 103 supported by the transportation system 102 will typically be a ground-based vehicle, such as an automobile. That said, an AV 103 supported by the transportation system 102 can also be an aircraft, such as a flying drone device. The transportation system 102 may also include one or more backend server systems, which may be cloud-based, network-based, or resident at the particular campus or geographical location serviced by the transportation system 102. The backend system can communicate with the user devices 104 operated by passengers to schedule rides, dispatch the vehicles 103, and the like. In addition, the backend system can communicate with the security and access system 106, the shipping/delivery system 108, and/or the navigation and map system 110 as needed.

The operating environment 100 can include any number of predefined vehicle pickup/drop-off locations that are known to the transportation system 102. Alternatively or additionally, the transportation system 102 can leverage GPS technology (and/or other position or location determination techniques or methodologies) to pick up passengers at any location and/or to leave passengers at any desired destination location. In accordance with a typical use case workflow, a registered user of the transportation system 102 can create a ride request via the user device 104. The ride request will typically indicate the passenger's desired pickup location (or current GPS location), the desired destination location (which may identify a predefined vehicle stop and/or a user-specified passenger destination), and a desired pickup time. The transportation system 102 receives the ride request, processes the request, and dispatches an autonomous vehicle 103 (when and if one is available) to pick up the passenger at the designated pickup location and at the appropriate time. The transportation system 102 can also generate and send a suitably configured confirmation message or notification to the passenger, to let the passenger know that a vehicle 103 is on the way. Any vehicle in the transportation system 102 can be outfitted with a secure package or object delivery unit (a “delivery compartment”) that allows the vehicle to securely deliver packages, objects, documents, goods, parts, etc. from one location to another within the operating environment 100.

The security and access system 106 can be an independent and distinct subsystem, or it can be integrated with the transportation system 102 and/or any of the other systems described herein. The security and access system 106 may be implemented with one or more backend server systems, which may be cloud-based, network-based, or resident at the particular campus or geographical location serviced by the transportation system 102. The security and access system 106 regulates and controls access to secured locations, which may include, without limitation: buildings, structures, rooms, regions, floors, offices, gates, doors, cabinets, sections of a building, areas, zones, closets, sections, hallways, passageways, corridors, lockers, containers, storage devices, or the like. The security and access system 106 can grant access to registered users as needed. In certain embodiments, the security and access system 106 utilizes: security badges or cards; RFID tags; fingerprint scanners; bar code readers; biometric scanners; keypads; or the like. In certain embodiments, the autonomous vehicles 103 controlled by the transportation system 102 include compatible onboard security and access hardware that can be used to verify the identity of the passengers. The security and access system 106 can also be utilized to grant access rights to locked delivery compartments onboard the autonomous vehicles.

The shipping/delivery system 108 can be an independent and distinct subsystem, or it can be integrated with the transportation system 102 and/or any of the other systems described herein. The shipping/delivery system 108 may be implemented with one or more backend server systems, which may be cloud-based, network-based, or resident at the particular campus or geographical location serviced by the transportation system 102. The shipping/delivery system 108 can be used to schedule, regulate, and control the delivery of packages, parts, products, or any object from one location to another, using the autonomous vehicles 103. To this end, the shipping/delivery system 108 may include or cooperate with the secure delivery compartments onboard the vehicles (e.g., lockers, trunk space, or storage units onboard or carried by the vehicles). In addition, the shipping/delivery system 108 may cooperate with the security and access system 106 to grant access to the secure features of the shipping/delivery system 108 if so desired. For example, if an autonomous vehicle 103 is used to transport a package to a destination location, the shipping/delivery system 108 and the security and access system 106 may cooperate to grant unlock or access privileges only to certain authorized or selected registered users. Thus, an authorized user with unlock/access privileges will be able to retrieve the package, object, or item from the vehicle 103 when it arrives at the destination location.

The navigation and map system 110 can be an independent and distinct subsystem, or it can be integrated with the transportation system 102 and/or any of the other systems described herein. The navigation and map system 110 may be implemented with one or more backend server systems, which may be cloud-based, network-based, or resident at the particular campus or geographical location serviced by the transportation system 102. In some embodiments, the navigation and map system 110 includes or cooperates with compatible features, functions, or applications resident at the autonomous vehicles 103 and/or resident at the user devices 104. For example, a user device 104 may include a locally installed navigation or mapping app that receives and processes data provided by the navigation and map system 110. In this regard, the user device 104 may leverage cached map data, or it may rely on map data provided via the communication network 112. As explained in more detail below, the navigation and map system 110 can be used to determine the passenger transportation routes to be followed by each actively operating autonomous vehicle in the environment 100.

The communication network 112 provides and supports data connectivity between the various components and systems in the operating environment 100. In practice, the communication network 112 may be any digital or other communications network capable of transmitting messages or data between devices, systems, or components. In certain embodiments, the communication network 112 includes a packet switched network that facilitates packet-based data communication, addressing, and data routing. The packet switched network could be, for example, a wide area network, the Internet, or the like. In various embodiments, the communication network 112 includes any number of public or private data connections, links or network connections supporting any number of communications protocols. The communication network 112 may include the Internet, for example, or any other network based upon TCP/IP or other conventional protocols. In various embodiments, the communication network 112 could also incorporate a wireless and/or wired telephone network, such as a cellular communications network for communicating with mobile phones, personal digital assistants, and/or the like. The communication network 112 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

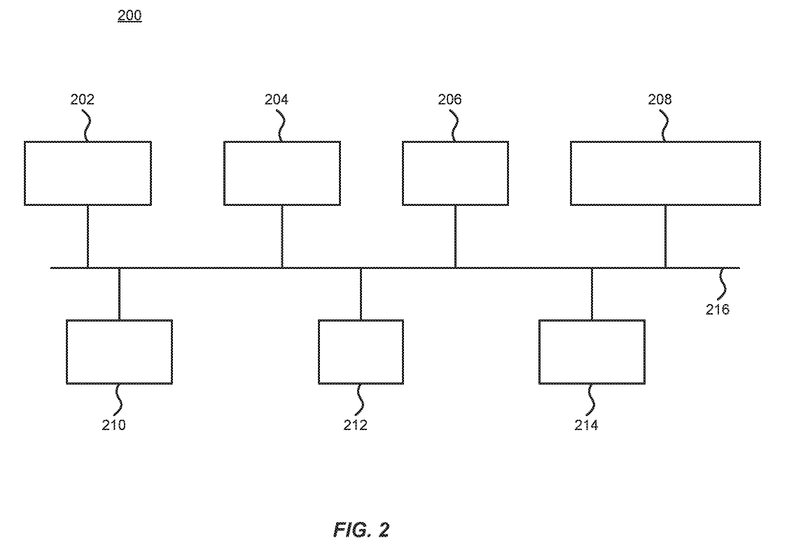

The various systems, devices, and components in the operating environment 100 may include or cooperate with computer-based or processor-based hardware. In this regard, FIG. 2 is a block diagram of an exemplary embodiment of a hardware platform 200 suitable for use in the operating environment 100. More specifically, at least one instantiation of the hardware platform 200 (or something similar) can be utilized with each of the elements depicted in FIG. 1. Moreover, at least one instantiation of the hardware platform 200 (or something similar) can be deployed in each of the autonomous vehicles 103, for example, as an onboard electronic control unit. The hardware platform 200 is implemented as a processor-based or computer-based device, system, or component that is designed, configured, and programmed to meet the needs of the particular system or subsystem.

The illustrated embodiment of the hardware platform 200 includes, without limitation: a processor architecture 202 having at least one processor device; a suitable amount of memory 204, which includes at least one computer/processor readable media element; a data storage apparatus 206; device-specific hardware, software, firmware, and/or features 208; a user interface 210; a communication module 212; and a display element 214. Of course, the hardware platform 200 may include additional elements, components, modules, and functionality configured to support various features that are unrelated to the subject matter described here. For example, the hardware platform 200 may include certain features and elements to support conventional functions that might be related to the particular implementation and deployment of the hardware platform 200. In practice, the elements of the hardware platform 200 may be coupled together via a bus or any suitable interconnection architecture 218.

The processor architecture 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. Moreover, the processor architecture 202 may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor architecture 202 such that the processor architecture 202 can read information from, and write information to, the memory 204. In the alternative, the memory 204 may be integral to the processor architecture 202. As an example, the processor architecture 202 and the memory 204 may reside in an ASIC. At least a portion of the memory 204 can be realized as a computer storage medium, e.g., a tangible computer readable media element having non-transitory processor-executable instructions stored thereon. The computer-executable instructions can be configurable such that, when read and executed by the processor architecture 202, cause the hardware platform 200 to perform certain tasks, operations, functions, and processes described in more detail herein. In this regard, the memory 204 may represent one suitable implementation of such computer-readable media. Alternatively or additionally, the hardware platform 200 could receive and cooperate with computer-readable media (not separately shown) that is realized as a portable or mobile component or platform, e.g., a portable hard drive, a USB flash drive, an optical disc, or the like.

The data storage apparatus 206 can be realized with the memory 204, or it can be implemented as a physically distinct component. The data storage apparatus 206 employs a nonvolatile storage technology to save and maintain data as needed. For example, the data storage apparatus 206 can include flash memory and/or a hard disk formatted to save data that is generated and used by the corresponding host system.

The device-specific hardware, software, firmware, and features 208 may vary from one embodiment of the hardware platform 200 to another. For example, the device-specific hardware, software, firmware, and features 208 will support telephone functions and features when the hardware platform 200 is realized as a mobile telephone, conventional personal computer functions and features if hardware platform 200 is realized as a laptop or tablet computer, vehicle-centric functions and features if the hardware platform 200 is realized as an onboard electronic control unit, etc. For the exemplary embodiments described here, the autonomous vehicles and the user devices 104 can include GPS receivers and/or other location determining hardware and functionality integrated therein. Thus, the vehicles and/or the user devices 104 can communicate with the GPS satellites 114 and process geographical position information to calculate their current geographical positions. In practice, certain portions or aspects of the device-specific hardware, software, firmware, and features 208 may be implemented in one or more of the other blocks depicted in FIG. 2.

The user interface 210 may include or cooperate with various features to allow a user to interact with the hardware platform 200. Accordingly, the user interface 210 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the hardware platform 200. The user interface 210 may include one or more graphical user interface (GUI) control elements that enable a user to manipulate or otherwise interact with an application via the display element 214.

The communication module 212 facilitates data communication between the hardware platform 200 and other components as needed during the operation of the hardware platform 200. Referring again to FIG. 1, the communication module 212 (of the user device 104) enables the user device 104 to communicate with the transportation system 102, the security and access system 106, the navigation and map system 110, and/or the shipping/delivery system 108 as needed. Similarly, the communication module 212 (of the security and access system 106) enables the security and access system 106 to communicate with the transportation system 102 as needed. In practice, an embodiment of the hardware platform 200 may support wireless data communication and/or wired data communication, using various data communication protocols. For example, the communication module 212 could support one or more wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Moreover, the communication module 212 could support one or more wired/cabled data communication protocols, including, without limitation: Ethernet; home network communication protocols; USB; IEEE 1394 (Firewire); hospital network communication protocols; and proprietary data communication protocols.

The display element 214 is suitably configured to enable the hardware platform 200 to render and display various screens, GUIs, GUI control elements, drop down menus, auto-fill fields, text entry fields, message fields, or the like. Of course, the display element 214 may also be utilized for the display of other information during the operation of the hardware platform 200, as is well understood. Notably, the specific configuration, operating characteristics, size, resolution, and functionality of the display element 214 can vary depending upon the practical implementation of the hardware platform 200. For example, if the hardware platform 200 is a laptop computer, then the display element 214 may be a relatively large monitor. Alternatively, if the hardware platform 200 is a cellular telephone device, then the display element 214 may be a relatively small integrated display screen, which may be realized as a touch screen. When the hardware platform 200 is implemented onboard a vehicle 103, the display element 214 can be integrated in an instrument panel, an instrument cluster, a head-up display, or the like.

The autonomous vehicle based transportation system 102 described here can be suitably configured to provide enhanced passenger convenience features. In accordance with certain embodiments, the transportation system 102 leverages GPS position data to obtain or determine the current geographical position of the autonomous vehicles 103 and to obtain or determine the current geographical position of the passengers (or the passenger devices) in the field. The real-time geographical position information can then be processed to calculate each passenger transportation route to be followed by the vehicles 103. In accordance with other embodiments, the transportation system 102 is linked to the shipping/delivery system 108 to enable the driverless vehicles 103 to deliver packages or objects in a safe and secure manner. Of course, any or all of these enhanced features can be supported, depending on the particular implementation of the operating environment 100.

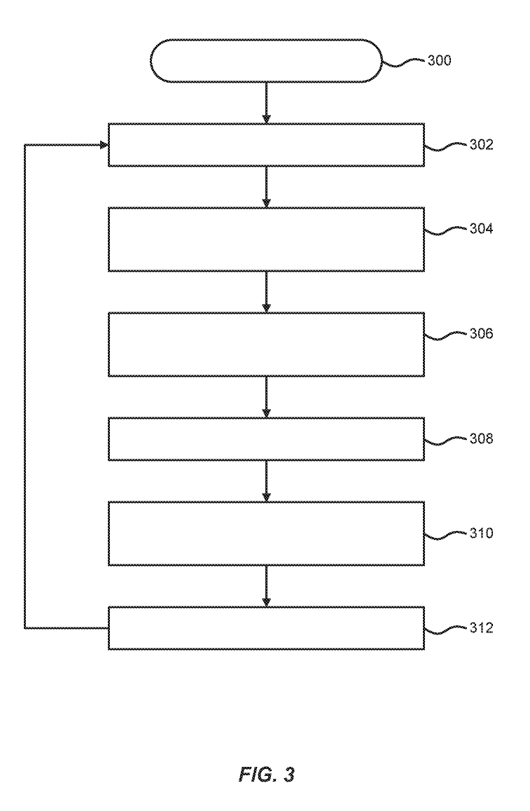

FIG. 3 is a flow chart that illustrates an exemplary embodiment of a passenger pickup and drop-off process 300. The various tasks performed in connection with a process or method described herein may be performed by software, hardware, firmware, or any combination thereof. For illustrative purposes, the following description of the process 300 may refer to elements mentioned above in connection with FIGS. 1 and 2. In practice, portions of a described process may be performed by different elements of the described system, e.g., the transportation system 102, the user device 104, an autonomous vehicle of the transportation system 102, or the security and access system 106. It should be appreciated that an embodiment of an illustrated process may include any number of additional or alternative tasks, the tasks shown a figure need not be performed in the illustrated order, and a described process may be incorporated into a more comprehensive procedure or process having additional functionality not described in detail herein. Moreover, one or more of the tasks shown in a figure could be omitted from an embodiment of the illustrated process as long as the intended overall functionality remains intact.

The exemplary embodiment of the process 300 receives and processes ride (pickup) requests for multiple and different passengers or parties of an autonomous vehicle based transportation system (task 302). Task 302 can be performed by a centralized dispatch center, module, or server of the transportation system 102 such that the various autonomous vehicles operating in the transportation system 102 can be dispatched and controlled in an efficient and effective manner. In a typical scenario, each of the ride requests is initiated or created by a potential passenger or by any registered or authorized user of the transportation system 102. For example, a ride request can be created and sent from a user device 104, either by the passenger or on behalf of the passenger. Although not always required, this example assumes that each ride request includes, identifies, or is otherwise associated with at least the following information: the passenger (by username, actual given name, an ID number, or the like); a pickup location (which may be a predefined and fixed vehicle pickup/drop-off location, or a current real-time geographic position of the user); and a destination location. Each ride request may also specify a preferred pickup time, a desired destination time, the number of passengers, whether or not the request is for a package delivery, and/or other options or preferences.

A destination location may be, without limitation: a building; a predefined pickup/drop-off location of the transportation system; an intersection; an area of a campus; an address; a mailstop; or the like. In certain scenarios, the process 300 can calculate or derive a predefined drop-off location based on a passenger-entered destination and/or based on the current real-time position of a passenger's electronic device or a dedicated location transmitter (e.g., GPS location) as reported at the time of the ride request. In certain scenarios, the ride request can identify a specific passenger destination that is different than a predefined and stationary drop-off location. In this regard, the passenger destination may be any of the following, without limitation: a structure, building, room, area, zone, closet, section, hallway, passageway, corridor, locker, container, office, storage device, or the like, which may be located at or near a designated drop-off location. For example, the ride request may identify a particular vehicle stop near Building A of a campus, along with an identifiable conference room within Building A as the passenger's desired destination.

After receiving and processing a new ride request, the process 300 may send a confirmation to the passenger. The confirmation indicates that the ride request has been processed and that a vehicle has been (or will be) dispatched. Under some conditions, the confirmation indicates that the ride request cannot be immediately satisfied, or that an autonomous vehicle will be delayed.

The process 300 obtains or determines the current location or geographical position of each autonomous vehicle that is active or on standby within the service area (task 304). In practice, task 304 can be associated with the reported GPS location of each vehicle as calculated by a suitably configured GPS receiver onboard each vehicle. Alternatively or additionally, task 304 can leverage other location/positioning techniques and technologies, including, without limitation: cell site location information; wireless access point information and related triangulation methodologies; RFID technology; sensor data collected by onboard sensor equipment; or the like. Similarly, the process 300 obtains or determines the current location or geographical position of each passenger (task 306). In this regard, task 306 can leverage the GPS receivers integrated into an electronic user device 104 in the possession of each passenger, such as a smartphone. Alternatively or additionally, task 306 can leverage other location/positioning techniques and technologies, including, without limitation: cell site location information; wireless access point information and related triangulation methodologies; RFID technology; sensor data collected by sensors onboard the electronic user devices 104; or the like. The process 300 can update the passenger's location as needed; such updating may be necessary to track the movement of a non-stationary passenger (e.g., one who is walking, riding a bicycle, rollerblading, riding a skateboard, or the like.

Notably, task 304 is performed to obtain the current real-time locations of the autonomous vehicles, whether they are in standby mode waiting to be dispatched or have already been dispatched and are travelling within the operating environment 100. Likewise, task 306 can be performed to obtain the current real-time locations of the passengers, whether they are waiting for pickup at a stationary location, waiting for pickup while walking or moving about, or are travelling in an autonomous vehicle.

The process 300 also identifies the pickup locations and destination locations (if applicable) associated with the received ride requests (task 308). Task 308 assumes that at least one of the ride requests actually identifies a predefined and stationary pickup location or a static destination location. In practice, however, the process 300 can support dynamically changing pickup locations that correspond to passengers “on the move” while waiting for a pickup. Likewise, the process 300 can support dynamically changing drop-off or destination locations. For example, if a passenger in transit decides to change his or her destination, then the process 300 can be updated as needed to respond to the change in real-time. For dynamically changing pickup locations, the real-time geographic position of a passenger or a user device in the possession of a passenger can be reported to the transportation system 102 as often as needed.

During each iteration of the process 300, an “optimized” or otherwise preferred passenger transportation route is calculated for each active autonomous vehicle (task 310). A desired route can be initially calculated for vehicles that have not yet been dispatched into the field. An existing route can be updated or otherwise supplemented if needed for vehicles that are already dispatched and travelling within the operating environment 100. The process 300 continues by controlling the operation of the active vehicles in accordance with their respective routes (task 312). In this way, the autonomous vehicles are controlled and operated in a manner that satisfies at least some of the ride requests in an efficient, effective, and passenger-convenient way.

Each passenger transportation route is calculated based at least in part on the currently determined pickup locations and the currently determined destination locations associated with the ride requests. Moreover, each route can be calculated based on the current geographical position of the respective vehicle and the current geographical position of the corresponding passenger(s) or passenger device(s) that are “assigned” to the vehicle. The exemplary embodiment described here uses predetermined prioritization criteria during the route calculation in task 310. Depending on the particular implementation of the autonomous vehicle transportation system 102, the prioritization criteria prioritization can be based on one or more of the following considerations, without limitation: fuel economy, energy conservation, travel time between vehicle stops, passenger identification or status, travel time between a next planned vehicle stop and a last vehicle stop, or the like. Notably, the calculation performed at task 310 for a given autonomous vehicle can disregard a particular ride request to eliminate the pickup (or drop-off) location associated with that ride request. Thus, a specified passenger transportation route can be generated while ignoring (or temporarily disregarding) one or more ride requests if doing so results in a better optimized route plan for existing passengers or for other ride requests. It should be appreciated that the process 300 can manage and arbitrate passenger pickups and drop-offs for any number of autonomous vehicles in an ongoing manner. Accordingly, FIG. 3 depicts task 312 leading back to task 302 to perform another iteration of the process 300 using updated information and position data if available.

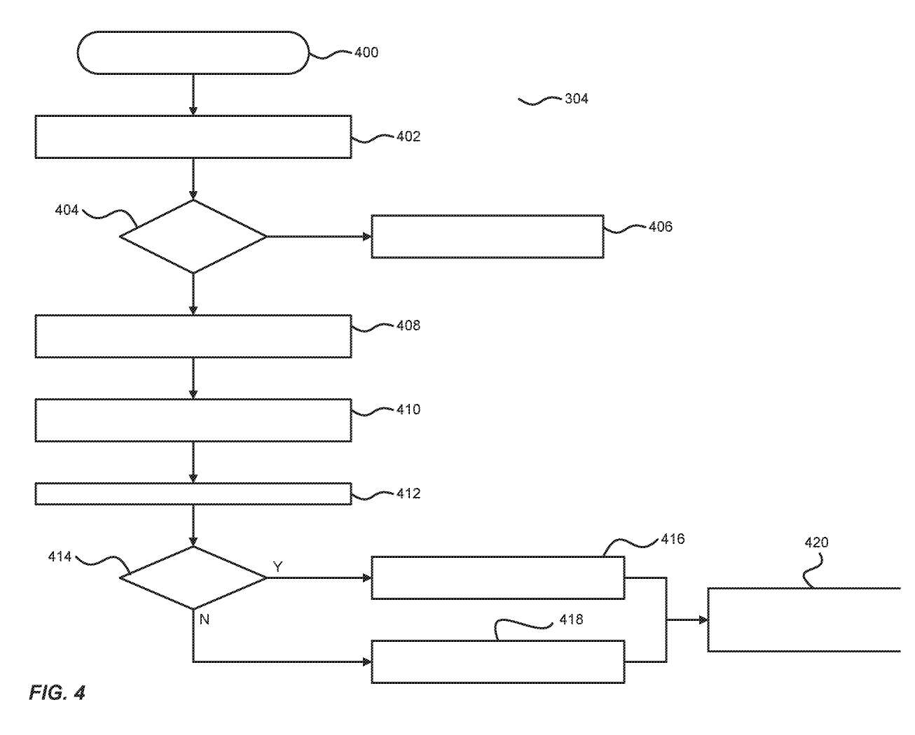

As mentioned above, the transportation system supports the dispatching of vehicles (which may be autonomous vehicles) to pick up passengers on demand. In certain implementations, the system can dispatch and operate a vehicle in an intelligent and responsive manner that reacts to current traffic conditions, movement of the passenger, and/or other factors. To this end, FIG. 4 is a flow chart that illustrates an exemplary embodiment of a “rendezvous anywhere” process 400 that can be performed by the transportation system when picking up a passenger. The process 400 may leverage some of the features and functionality described above with reference to FIG. 3, and common aspects and tasks will not be redundantly described here in the context of the process 400.

The process 400 begins by receiving and processing a reservation or ride request for a requestor/passenger (task 402). This example assumes that the request is communicated from a wireless device, such as a smartphone owned or operated by the requestor. The request may also identify a real-time geographic position of the passenger or a user device in the possession of the passenger. The process 400 confirms whether or not any vehicles are available (query task 404). If not (the “No” branch of query task 404), then the transportation system responds to the requestor in an appropriate manner (task 406). For example, the system may respond with a suitably formatted message that informs the requestor that no vehicles are currently available. If at least one vehicle is available for dispatch (the “Yes” branch of query task 404), then the transportation system responds with a map showing the locations of the available vehicles (task 408). Alternatively, the system can respond with a simple message that lets the requestor know that a vehicle is available and will be dispatched to pick up the requestor. As yet another option, the system can respond with a selectable list of available vehicles.

This description assumes that the requestor is given the opportunity to select a vehicle for the ride. Accordingly, the process 400 continues by receiving the requestor's vehicle selection (task 410). The selected vehicle can then be dispatched to pick up the passenger. The illustrated embodiment of the process 400 obtains or determines the current location and movement (if any) of the requestor (task 412) for purposes of directing and routing the dispatched vehicle. In this regard, the transportation system can calculate a dispatch route for the vehicle, based on a designated or calculated pickup location.

If the requestor's location is stationary (the “Yes” branch of query task 414), then the dispatch route followed by the vehicle is based on a target that corresponds to an address and the requestor's device (task 416), and operation of the vehicle is controlled in an appropriate manner to arrive at the desired pickup location. If the requestor is on the move (i.e., the requestor's location is not stationary), then the vehicle is controlled to target only the requestor's device (task 418). In other words, the process 400 will continuously track the location of the requestor's wireless device, under the assumption that the requestor's real-time location corresponds to the real-time location of the wireless device. Thus, the vehicle is operated according to the desired target to rendezvous with the requestor (task 420), whether the requestor remains at or near the same pickup location or is walking, moving, or otherwise traveling while the vehicle is in transit.

In certain implementations, the process 400 forecasts a final pickup location for the passenger, based on vehicle status data, the current location of the passenger, and movement of the passenger (if any). If the passenger is moving while the dispatched vehicle is in transit, then an accurate forecast will ensure that the vehicle “intercepts” the passenger at an appropriate time. Thus, the dispatch route followed by the vehicle might be altered in transit to accommodate movement of the passenger and to adjust the forecasted final pickup location. The forecasting algorithm carried out by the process 400 may consider any of the following types of vehicle status data, without limitation: vehicle speed data, vehicle acceleration data, vehicle trajectory data, geographical position data for the vehicle, vehicle navigation data, and/or map data. Alternatively or additionally, the forecasting algorithm performed by the process 400 may consider any of the following data, without limitation: terrain data for terrain near the passenger, road terrain data, traffic data, weather data, pickup location data (e.g., designated or safe pickup locations near the current location of the passenger), and/or emergency services data. Any or all of this data can be utilized to predict the rendezvous time and the rendezvous location (i.e., the final pickup spot) where the dispatched vehicle will meet the passenger.

In accordance with certain embodiments, the process 400 activates a beacon element onboard the dispatched vehicle when the vehicle is within a predetermined range of the current location of the passenger. For example, the beacon element can be activated when the system determines that the distance between the vehicle and the passenger's mobile device is less than 500 feet. Activation of the beacon element serves as a notification, signal, or alert to the passenger. In this regard, the process 400 may activate a door handle of the vehicle (such as the passenger door handle) for use as a beacon target. The activation may involve the activation of a light or a display onboard the vehicle for use as a beacon target. For example, a lighted door handle can be unlocked and illuminated when the vehicle approaches the passenger. Alternatively or additionally, the system can generate an audible alert sound from an onboard speaker and/or at the requestor's mobile device if so desired.

It should be appreciated that the processing intelligence, control methodologies, and other functionality described above may reside at one or more of the components and systems of the operating environment. In certain implementations, for example, most of the processing intelligence is carried out by the various network-based systems, and the autonomous vehicles and the user devices play a secondary role. In other implementations, however, more of the processing load can be handled by the user devices and/or by the computer-based systems onboard the autonomous vehicles. Moreover, although FIG. 1 depicts distinct blocks for the transportation system 102, the security and access system 106, the shipping/delivery system 108, and the navigation and map system 110, the functionality of these systems can be combined and implemented in one or more hardware platforms. These and other hardware realizations are contemplated by this disclosure.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method comprising:
processing a plurality of ride requests for multiple passengers of an autonomous vehicle based transportation system, each of the ride requests being associated with a respective pickup location, and a respective destination location;
calculating, for each actively operating autonomous vehicle in the transportation system, a respective passenger transportation route, wherein each passenger transportation route is based at least in part on the pickup locations and destination locations associated with the ride requests, and wherein each passenger transportation route is calculated in accordance with predetermined prioritization criteria; and
controlling operation of the actively operating autonomous vehicles to satisfy at least some of the ride requests.

2. The method of claim 1, wherein a ride request identifies a predefined and stationary pickup location.

3. The method of claim 1, wherein a ride request identifies a real-time geographic position of a passenger or a user device in the possession of a passenger.

4. The method of claim 1, wherein the calculating comprises disregarding a particular ride request to eliminate the pickup location associated with the particular ride request from one of the passenger transportation routes.

5. The method of claim 1, wherein the predetermined prioritization criteria is based on fuel economy, energy conservation, travel time between vehicle stops, passenger identification or status, and/or travel time between a next vehicle stop and a last vehicle stop.

6. The method of claim 1, further comprising delivering a package, object, or item using a particular autonomous vehicle of the transportation system.

7. The method of claim 6, wherein the particular autonomous vehicle comprises a secure compartment, locker, trunk space, or storage unit, and the method further comprises granting unlock or access privileges only to authorized registered users to allow the authorized registered users to retrieve the package, object, or item.

8. A computer-based system comprising a memory element and a processor device communicatively coupled to the memory element, the memory element having computer-executable instructions stored thereon and configurable to be executed by the processor to cause the computer-based system to:
process a plurality of ride requests for multiple passengers of an autonomous vehicle based transportation system, each of the ride requests being associated with a respective pickup location, and a respective destination location;
calculate, for each actively operating autonomous vehicle in the transportation system, a respective passenger transportation route, wherein each passenger transportation route is based at least in part on the pickup locations and destination locations associated with the ride requests, and wherein each passenger transportation route is calculated in accordance with predetermined prioritization criteria; and
control operation of the actively operating autonomous vehicles to satisfy at least some of the ride requests.

9. The computer-based system of claim 8, wherein a ride request identifies a predefined and stationary pickup location.

10. The computer-based system of claim 8, wherein a ride request identifies a real-time geographic position of a passenger or a user device in the possession of a passenger.

11. The computer-based system of claim 8, wherein calculating the respective passenger transportation routes comprises disregarding a particular ride request to eliminate the pickup location associated with the particular ride request from one of the passenger transportation routes.

12. The computer-based system of claim 8, wherein the predetermined prioritization criteria is based on fuel economy, energy conservation, travel time between vehicle stops, passenger identification or status, and/or travel time between a next vehicle stop and a last vehicle stop.

13. A method comprising:
processing a ride request for a passenger of a vehicle based transportation system;
dispatching a vehicle of the vehicle based transportation to pick up the passenger;
determining a current location and movement of the passenger;
forecasting a final pickup location for the passenger, based on vehicle status data and the current location and movement of the passenger; and
controlling operation of the vehicle to arrive at the final pickup location.

14. The method of claim 13, further comprising:
calculating a dispatch route for the vehicle, based on the final pickup location, wherein the controlling causes the vehicle to follow the dispatch route.

15. The method of claim 13, wherein the ride request identifies a real-time geographic position of the passenger or a user device in the possession of the passenger.

16. The method of claim 13, wherein the vehicle status data comprises vehicle speed data, vehicle acceleration data, vehicle trajectory data, geographical position data for the vehicle, vehicle navigation data, and/or map data.

17. The method of claim 13, wherein the forecasting is further based on terrain data for terrain near the passenger, traffic data, weather data, pickup location data, and/or emergency services data.

18. The method of claim 13, further comprising:
activating a beacon element onboard the vehicle when the vehicle is within a predetermined range of the current location of the passenger.

19. The method of claim 18, wherein the activating comprises activating a door handle of the vehicle for use as a beacon target.

20. The method of claim 18, wherein the activating comprises activating a light or a display onboard the vehicle for use as a beacon target.
